(19) United States
(12) Patent Application Publication
(10) Pub. No.: US 2010/0061179 A1
(43) Pub. Date: Mar. 11, 2010

(54) Paint system

(76) Inventors: Steven T. Lendzion, Commerce Twp., MI (US); James H, Kelly, Farmington Hills, MI (US)

Correspondence Address: L.C. Begin & Associates, PLLC, 510 Highland Avenue, PMB 403, Milford, MI, 48381, US

(21) Appl. No.: 12/584,956

(22) Filed: Sep. 14, 2009

Related U.S. Application Data
(63) Continuation-in-part of application No. 11/349,501, filed on Feb. 6, 2006, now abandoned.
(60) Provisional application No. 60/650,646, filed on Feb. 4, 2005.

(51) Int. Cl. B01F 15/02

(52) U.S. Cl. 366/134; 366/136

(57) ABSTRACT

A paint system containing at least one pump 150 and at least one paint mixing vessel 160. At least one return line 46 functions to route paint from the paint system back into the paint mixing vessel from whence it was drawn. At least one eductor 522 fluidly communicates with a respective paint mixing vessel 160 and a respective return line 46 whereby during operation of the paint system, as paint traverses through return line 46 and into eductor 522, paint is drawn from the respective paint mixing vessel 160 thereby mixing the paint drawn from the vessel with the paint in the return line 46.

### CROSS-REFERENCE TO RELATED APPLICATIONS

The present application is a continuation-in-part application of co-pending and co-owned U.S. application Ser. No. 11/349,501 having a filing date of Feb. 6, 2006, and claims priority thereto.

### BACKGROUND OF THE INVENTION

In large paint finishing facilities, paint materials are delivered to application points through a network of distribution pipes. The paint is generally pumped through the pipes from a central location (paint mix room or paint kitchen) designed for handling and storage of flammable and combustible liquids (e.g., solvent-based paints and/or water-based paints.) Various types of pumps are used for this purpose. The paint materials are adjusted to proper viscosity for application and contained in tanks connected to the pumps.

The paint is continually circulated between the mix room and the application points to prevent settling of pigments and metallic particles or similar appearance enhancers (mica, etc.) in the distribution pipes, which would result in sub-standard finish appearance on the painted product. Paint tank agitation methods commonly used to maintain mixing of the paint within the paint mixing vessel may employ a series of paddles, propeller, or serrated disks (FIGS. 2-5) connected to a drive shaft which, in turn, is connected to a gear motor or to a gear reducer and motor. In high volume production facilities such as automotive or similar production, electric motors ranging in horsepower from ½ to ten HP, depending on the mix tank size and paint properties are used to drive the agitators at the required speed.

The components of conventional paint agitation systems are generally bulky and expensive, and frequent, complex, and expensive maintenance procedures may be required to maintain these components in working order. Furthermore, the drive mechanism or motor for each agitator increases the cost of operating the paint system as well as increasing the maintenance requirements for the overall system. In particular, systems with multiple paint colors require an agitation means for each paint pot of the system. As the number of paint pots increase within a given system, the operating cost increases accordingly.

### BRIEF DESCRIPTION OF THE DRAWINGS

FIG. 1 is a schematic view of a paint circulating system in accordance with the present invention;

FIG. 2 is a cross-sectional view of a mix tank and an associated paint agitation system in FIG. 2 is a cross-sectional view of a mix tank and an associated paint agitation system in accordance with the present invention; and

FIG. 2A is a cross-sectional plan view of the mix tank shown in FIG. 2;

FIG. 3 is a cross-sectional view of an alternative embodiment of the mix tank and associated paint agitation system shown in FIG. 2; and

FIG. 3A is a cross-sectional plan view of the mix tank shown in FIG. 3.

FIGS. 4 and 5, when combined, disclose an exemplary paint system in accordance with the present invention.

FIG. 6 is a view of the system of FIGS. 4 and 5 in the paint recovery mode.

FIG. 7 is a view of the system of FIGS. 4 and 5 in the line flush mode;

FIG. 8 is a view of the spray gun line flush fluid circuit; and

FIG. 9 is a view of the pump flush fluid circuit.

FIGS. 10 and 11, when combined, is a view of a second paint line within a paint system of the present invention, thereby illustrating a plurality of paint lines within a paint system, particularly when combined with FIGS. 4 and 5.

### DETAILED DESCRIPTION

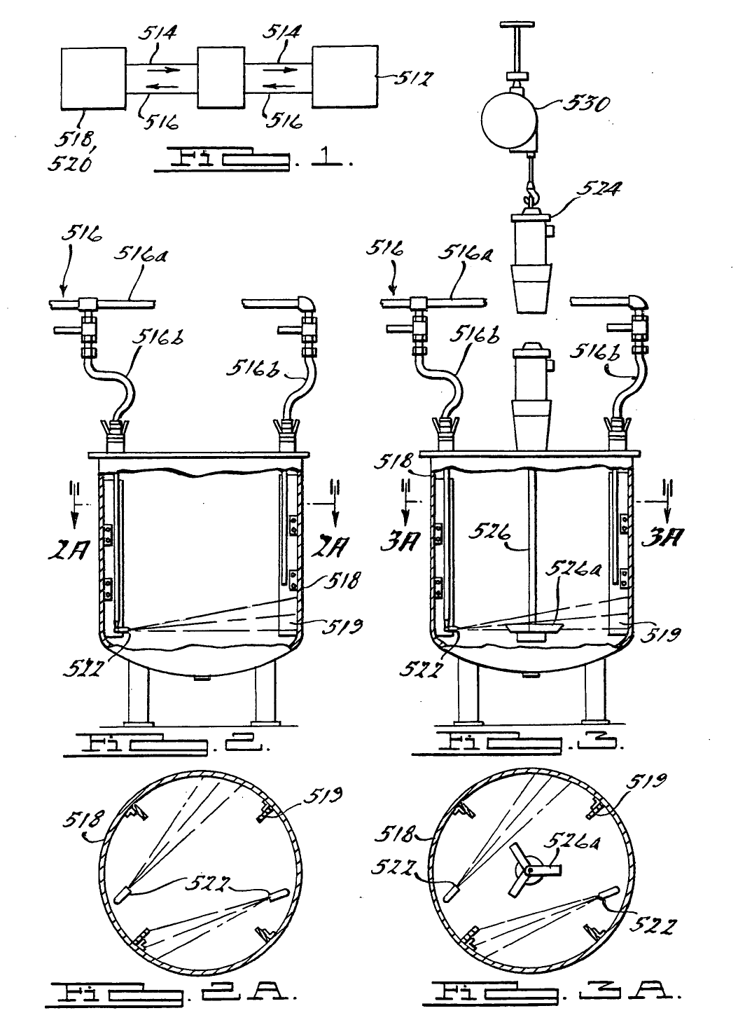

FIG. 1 shows a schematic of a paint circulating system 510 incorporating a paint agitation system 520 in accordance with the present invention.

Paint circulating system 510 includes a paint mix tank 518 for storing and mixing of the paint, a paint application area 512 (for example, a paint spray booth), at least one paint supply line 514 for conveying paint from mix tank 518 to paint application area 512, and at least one paint recovery or return line 516 for conveying paint from application area 512 to mix tank 518. Circulation of paint between mix tank 518 and application area 512 is provided and managed by a paint flow regulation system, generally designated 515.

Paint flow regulation system 515 comprises an arrangement of known elements, such as pumps, valves, pressure regulators, compressed air lines, and other components necessary for regulating flow of the paint between a paint reservoir (such as mix tank 518 of the present invention) and paint application area 512, in accordance with design requirements of the paint system. One example of such a flow regulation system is disclosed in U.S. Pat. No. 5,389,149, incorporated herein by reference. Numerous other known configurations of flow regulation system are possible and would be suitable for regulating paint flow in the paint circulating system described herein, depending on design requirements.

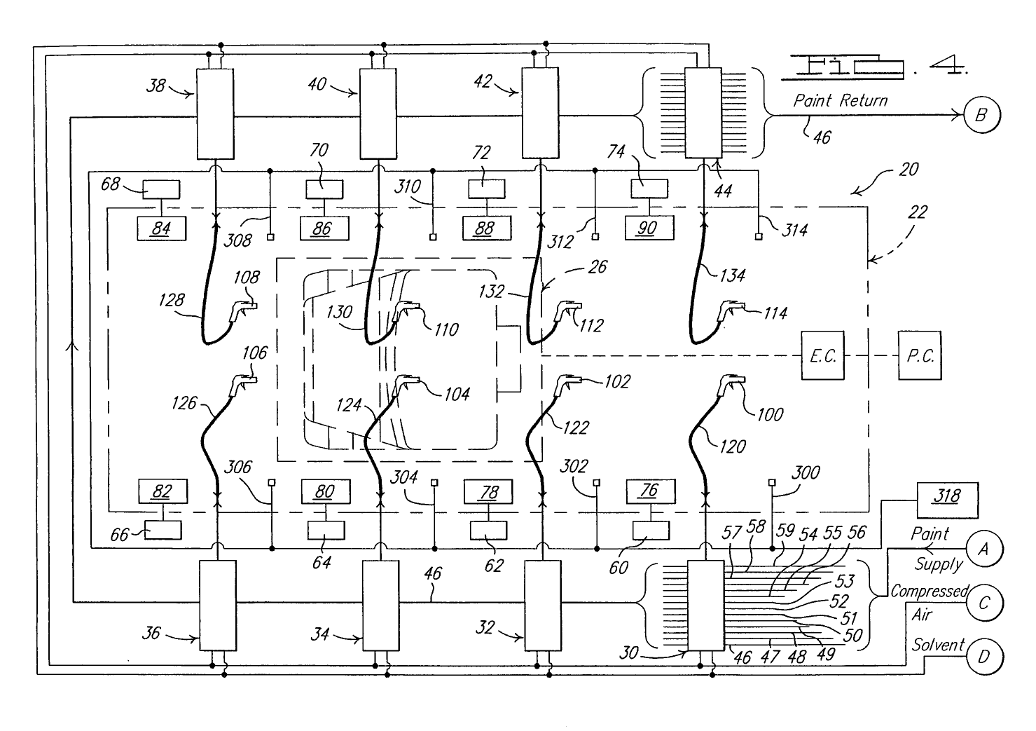

Paint recovery line 516 provides a conduit for conveying unused paint from paint application area 512 back to mix tank 518. In the embodiment shown in FIGS. 2 and 2A, one or more flexible branch lines 516b extend from a main line 516a. Branch lines 516b are fluidly coupled, via suitable piping or tubing, to eductors 522, described in greater detail below. The use of multiple branch lines 516b extending from main recovery line 516a enables multiple associated eductors 522 to be supplied with paint from the main return line. Because eductors 522 are fluidly coupled to paint recovery line 516, the pumps in paint flow regulation system 515 used to circulate the paint through the paint system can also be used to supply paint to the eductors.

FIG. 2 shows a cross-sectional view of a mix tank and an associated paint agitation system in accordance with the present invention. Mix tank 518 is provided for storing and mixing paint compounds. Mix tank may include one or more baffles 519 for disrupting paint flow patterns within tank 518, thereby increasing turbulence within the stored paint, in a manner known in the art.

The present invention uses the circulated paint returning to mix tank 518 to agitate the tank contents, using Coanda or Venturi effect eductors to amplify the volume of the returning paint to maintain required agitation of the tank contents, thereby eliminating or reducing the need for separate agitation devices. Referring again to FIG. 2, one or more eductors 522 are positioned proximate the bottom of mix tank 518 where settling of the paint constituents is most likely to occur. However, eductors 522 may alternatively be positioned at any suitable level within mix tank 518. In addition, multiple eductors 522 may be positioned at different levels within mix tank 518, depending upon such factors as the tank geometry and the mixing requirements of a particular paint composition.

The design and positioning of eductors 522 are optimized to produce a high turbulence in mixing tank 518 to prevent settling of pigments and metallic particles or similar appearance enhancers. Eductors 522 are known liquid eductors for agitating chemicals in tanks. One example of a suitable liquid eductor is manufactured by Fox Valve Development Corp. of Dover, N.J. In a Venturi-type eductor, for example, the paint is forced through a narrow or restricted area in the eductor, resulting in an increase in the speed of paint flow. The increased speed results in a reduction in pressure adjacent the accelerated fluid flow. This causes additional paint to flow through the eductor 522 thereby increasing the total paint volume through the eductor 522 and thus creating a high degree of agitation. Depending on the paint volume and pressure entering the eductor 522, the total paint volume through the eductor 522 may be amplified or increased by varying volumes of ten to possibly twenty times the volume entering the eductor 522, again leading to optimized agitation of the paint.

In certain applications, a paint mixture having highly pigmented constituents and dense settling characteristics may need supplemental agitation to overcome settling. Also, because of variable production requirements and variables that exist in the operation of paint mix facilities, including scheduled shutdowns, it may be necessary to provide additional, mechanical agitation of select tanks. Thus, in an alternative embodiment of the paint circulating system (shown in FIGS. 3 and 3A), a conventional agitation system may be incorporated into paint agitation system 520 to augment the mixing effects of eductors 522. The conventional agitation system may include an agitator drive unit 524 suspended from a load balancer 530, and an associated mechanical agitator 526 including a mixing paddle 526a. Agitator 526 and drive unit 524 may be fitted with complementary quick-disconnect features to enable drive unit 524 to be quickly disconnected from a first mix tank and reconnected to another mix tank having a similar design, as the need arises. It should be appreciated that the agitator drive unit 524, the load balancer 530, the agitator 526, and the agitator paddle 526a are optional, removable, and temporary, and only used to stir up the paint vessels after prolonged periods of inactivity, over shutdown periods for example.

Stated another way, the present invention counter-intuitively incorporates eductor mixers during steady state operation of the paint system as an exclusive means for mixing the paint, or after start-up of the system has been completed as explained below. Contrary to accepted belief, mechanical agitators are not necessary for the relatively thick and viscous paints, and in fact, homogeneous mixtures of the paint may be achieved through mixing exclusively accomplished by the eductor(s) 522. In the past, it has been widely accepted that paddles or mechanical agitators had to be incorporated in the paint vessels to achieve and maintain homogeneous mixtures of the paint during steady state operation of the paint system. As such, the overall energy requirements to run the paint system were substantially increased due to operating costs associated with the mechanical agitators. It will be appreciated that the term “mechanical agitator” in general means any mixing article that operates independently of the paint circulating pumps. As stated above, the eductors 522 are inventively combined with the recirculation pumps to achieve homogeneous mixing at a fraction of the electric costs generally absorbed during the paint process. The reduction in electric costs offers a substantial benefit not heretofore realized in paint systems developed to date. Accordingly, the present invention incorporates a paint system that is absent any mechanical agitation during steady state operation of the paint system. It will be appreciated that “steady state” in this context means operation of the paint system after all start-up procedures and accommodation have been satisfied.

The apparatus and principles set forth above may be applied to any suitable paint reservoir to provide needed agitation of the paint mixture.

The present invention offers several advantages. Use of eductors as set forth herein may obviate the need for conventional agitation systems. Thus, the present invention may enable the elimination (or a substantial reduction in the number) of expensive conventional agitation system components, such as explosion-proof electric agitator motors, explosion-proof wiring, and agitator motor starters and controls. Elimination or reduction of these components reduces agitation system maintenance time and associated costs, system power consumption, and system power feeds.

### Exemplary Paint System

Various paint systems are known in the art. In accordance with the present invention, and for example only, a description of a paint system incorporating the agitation means or mechanism of the present invention is described below.

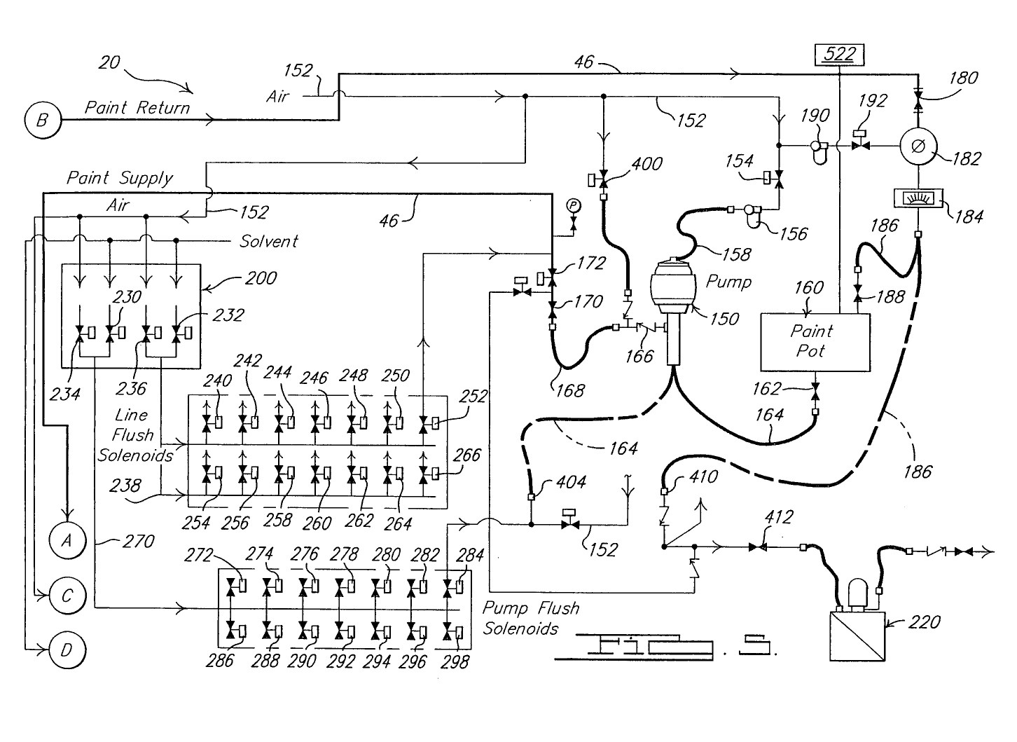

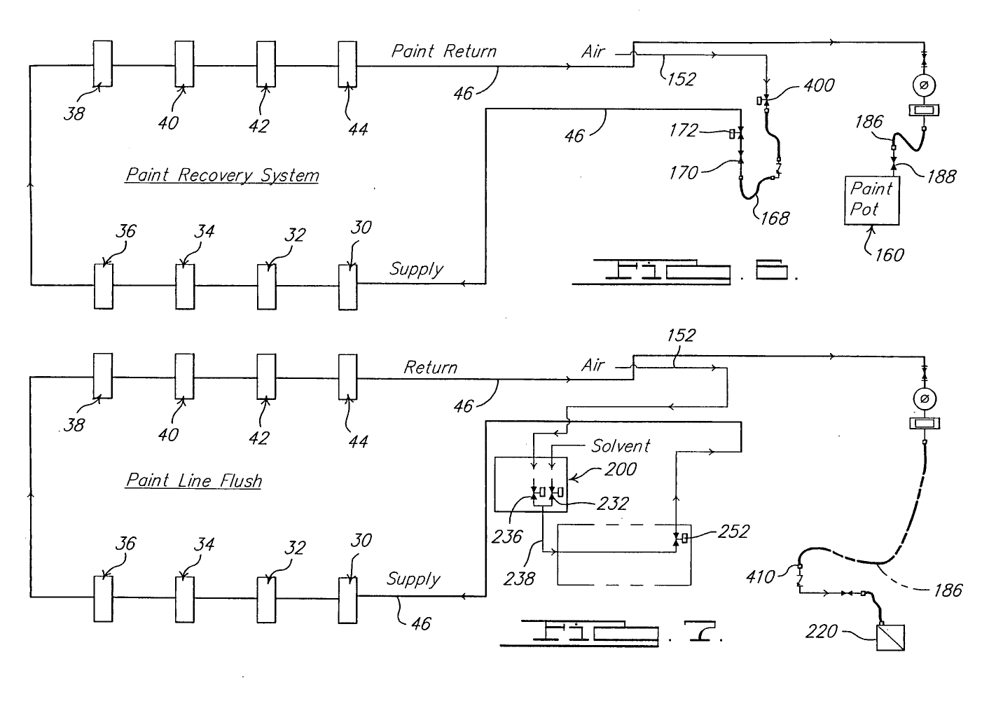

Referring to FIGS. 4 and 5 of the drawings, a paint system 20, in accordance with an exemplary constructed embodiment of the present invention, comprises a paint booth 22 that accommodates one or more vehicle bodies 24. Conventionally, the vehicle body 24 moves through the paint booth 22 on a skid 26. The essence of the instant invention is a paint system 20 that enables the vehicle 24 to be painted with a custom color in an economical manner from the standpoint of both time and paint utilization.

The paint system 20 comprises a plurality of color changers 30 through 44 that are connected, in series relationship, by, for example, fourteen (14) discrete paint lines 46 through 59. A paint line is provided for each color accommodated by the system. Thus, in the disclosed and constructed embodiment of the invention, fourteen (14) colors can be accommodated by the system 20. However, for purposes of clarity, only one line 46 is shown connecting the color changers 30 through 44 in series.

The color changers 30 through 44 are provided with solenoid valve panels 60 through 74, respectively, located exteriorly of the spray booth 22 which, in turn, are controlled by push buttons on a like plurality of push button panels 76 through 90, respectively, located internally of the spray booth 22.

Each of the color changers 30 through 44 services a spray gun 100 through 114, respectively, through discrete flexible paint supply lines 120 through 134, respectively.

Paint is supplied to the system 20 through, for example, the line 46 from a pump 150. It is to be understood that each of the paint lines 46 through 59 is supplied by a separate pump. Only the pump 150, paint line 46 and their associated supply and control system is discussed herein for purposes of clarity.

The pump 150 is energized by compressed air supplied thereto from a line 152 through a solenoid valve 154, pressure regulator 156, and flexible air line 158. Paint is supplied to the pump 150 from a paint pot 160 of, for example, 10 gallon capacity, through a ball valve 162 and flexible line 164. The pump 150 supplies paint under pressure to the line 46 through a check valve 166, flexible paint line 168, ball valve 170, and solenoid valve 172.

Paint is returned through a return portion of line 46 from the color changers 30 through 44, through a ball valve 180, back pressure regulator 182, flow meter 184, flexible paint return line 186, and ball valve 188 to the paint pot 160. The diaphragm of the back pressure regulator 182 is loaded by air pressure from the air line 152 through a regulator 190 and solenoid valve 192.

The system 20 is flushed by aerated solvent or foam produced in a turbulator 200. Aerated solvent flows from the turbulator 200 under the control of solenoid valves 230 and 232 for the solvent, and solenoid valves 234 and 236 for the air. The solvent flows through a line 238 to a bank of solenoid valves 240 through 266 and through a line 270 to a bank of solenoid valves 272 through 296, the function of which will be described hereinafter.

### Operation

The paint system 20 is conditioned for painting of a given color by connecting the paint supply hose 164 between the pump 150 and the paint supply solenoid 162 of a paint pot 160, containing a desired color. The paint return hose 186 is then connected from the flow meter 184 to the paint return ball valve 188 on the paint pot 160. The paint pot valves 162 and 188 are then opened.

The system 20 is electronically conditioned for start by entering a vehicle number, a paint code number, and paint line number into a conventional process control computer (PC). As a vehicle 24 enters the spray booth 22 a conventional encoder (EC) transmits vehicle position to the control computer. The computer will search its memory for the appropriate paint which has previously been loaded into a specific paint pot 160 of the paint system 20. When the paint number is found, the computer (PC) energizes the pump 150 and appropriate push button lights at each of the paint station push button consoles 76 through 90. Paint circulates continuously in line 46 through the color changers 30 through 44. In the example illustrated in the drawings, the push buttons at each console 76 through 90 would be lit that control the paint line 46. When the operator pushes any lighted push button at any console 76 through 90, paint flows from the associated color changer 30 through 44, respectively, to its associated spray gun. It is to be noted that in the example, only the lighted push buttons controlling line 46 can be activated.

After a predetermined spraying interval, the painter can either energize stop buttons on his associated control console 76 through 90 or the tracking logic in the encoder (EC) and computer (PC) shuts off the color valves controlling line 46 in the color changers 30 and 44.

### Spray Gun Line Flush

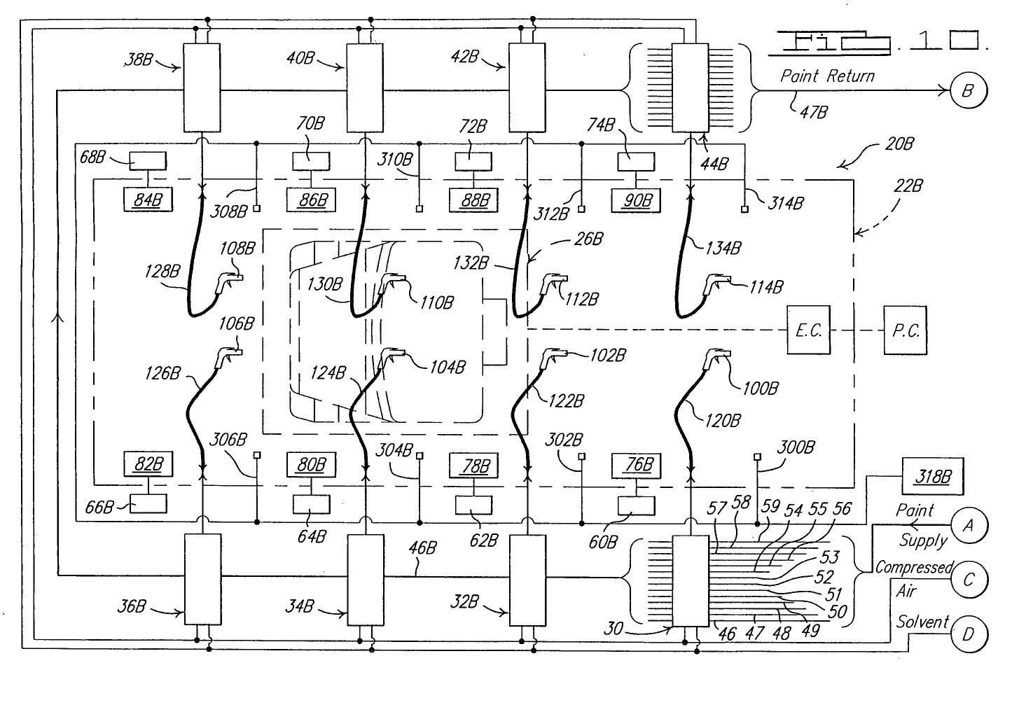

As best seen in FIG. 8, after a vehicle 24 passes a particular color changer 30 through 44, its associated spray gun line 120 through 134, respectively, is flushed. Flushing is initiated by first closing the color valve in a color changer 30 through 44 by pushing an appropriate push button on the corresponding color console 76 through 90. The painter then disengages an associated spray gun 100 through 114 from a gun line 120 through 134 and attaches the line 120 through 134 to an associated solvent flush connector 300 through 314, respectively. All of the connectors 300 through 314 are connected to a common solvent return line 316 thence to a solvent collection tank 318.

As shown in FIG. 8, the spray gun 100 has been detached from the spray gun line 120 and the line 120 has been reattached to the connector 300 of the solvent return line 316. The operator then presses a purge push button on the console 76 which automatically initiates a cleaning cycle of the color changer 30 and spray gun hose 120 by alternately opening the solvent and air solenoids of the color changers. The opening, closing and time duration sequence is controlled by the control computer. Solvent and air flows through the color changer 30 and line 120 for return to the tank 318. The lines 120 through 134 are flushed successively as the vehicle 24 moves through the spray booth 22.

### Paint Recovery

As best seen in FIG. 5 and in FIG. 6, after a vehicle 24 has passed through the booth 22 and there is no future requirement for the color, as dictated by the control computer (not shown), the paint line, for example paint line 46, is purged of paint. The control computer terminates the flow of paint by shutting off the pump 150 and then opening a paint blowdown valve 400 in air line 152 and closing valve 192 which fully opens the back pressure valve 182 so as to blow the paint through the line 46 back to the paint pot 160.

### Line Flushing

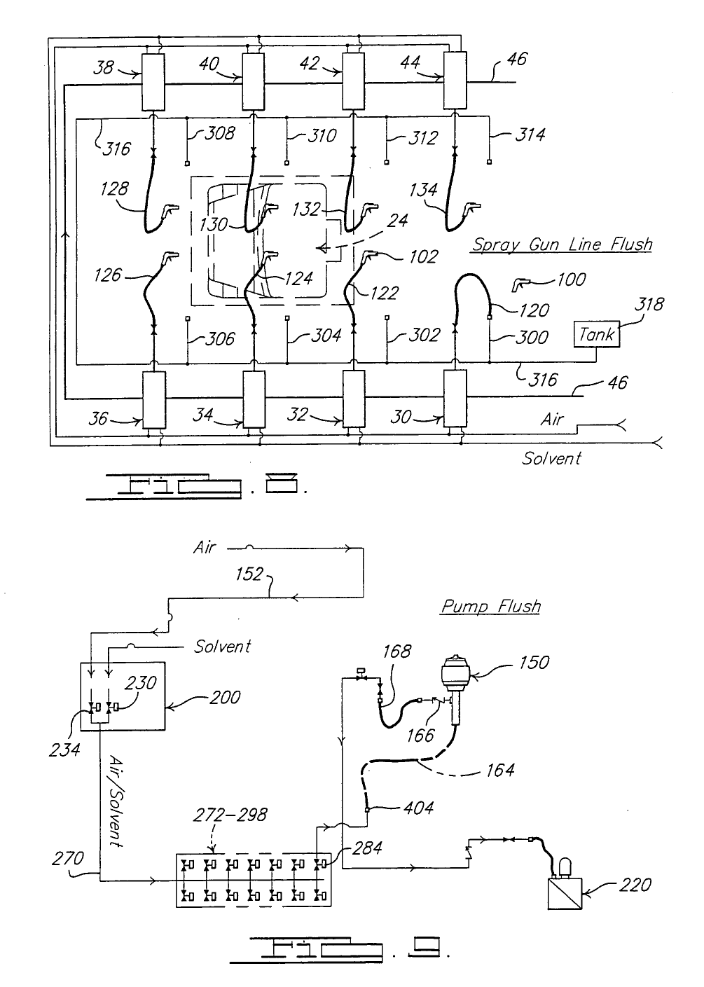

After the paint line has been cleared of paint, and as seen in FIG. 5 and in FIG. 7, the operator disconnects the paint inlet hose 186 from the paint pot 160 and connects it to a solvent connection 410. He then opens solvent and air line valves 236 and 232 so as to initiate foamed solvent flow through line 238, valve 252, lines 46 and 186 to tank 220. After a predetermined period the solvent valve 232 is closed to initiate flow of compressed air only to affect compressed air blowdown.

### Pump Flushing

As seen in FIG. 5 and FIG. 9, flushing of the pump 150 is initiated by disconnecting the pump inlet hose 164 from the paint pot 160 and connecting it to a solvent connection 404. A pump flush control is then energized opening the air and solvent valves 234 and 230, respectively, in the turbulator 200 and starting the pump 150. Solvent is pumped through the line 270, valve 284, line 164, pump 150, and line 168 to the tank 220. The solvent valve 230 is closed after a set period and compressed air only flows through the pump 150 effecting final blowdown.

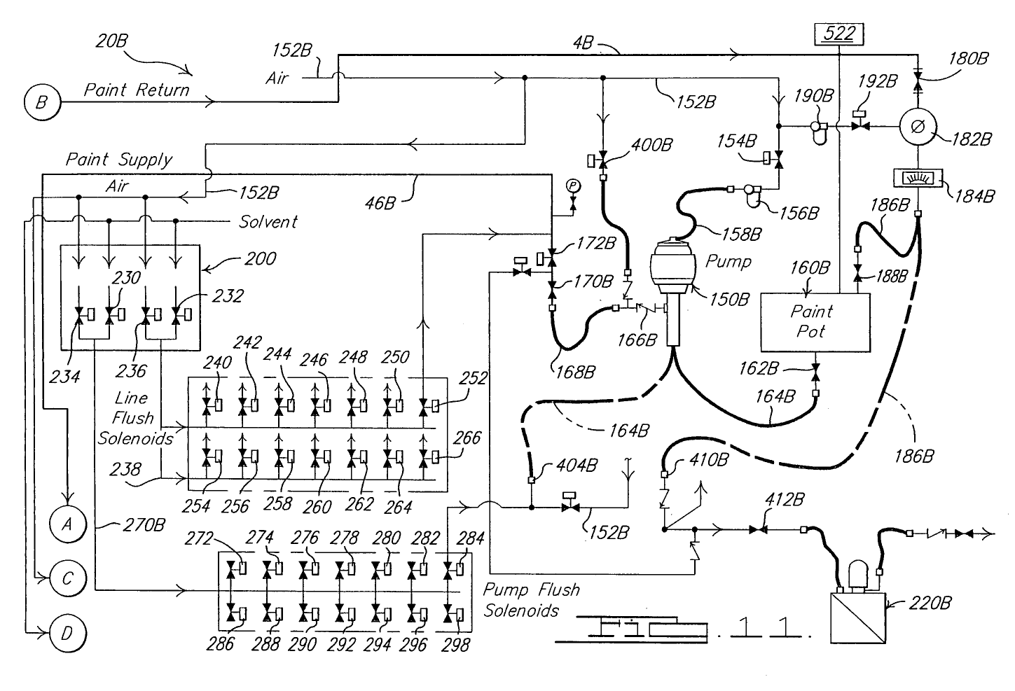

In accordance with the present invention, at least one eductor 522 is positioned in line with the paint return line 46, and also in fluid communication with the paint mixing vessel 160. As paint fluid flows through line 46 it necessarily draws paint from the paint pot 160 and then directs the fluid into the paint pot 160 as determined by design criteria. For example, the fluid flowing through paint return line 46 may be directed to the bottom of the paint pot 160 thereby providing an aggressive agitation of the paint within paint pot 160. It will be appreciated that each paint return line associated with a given color may contain an eductor/mixer 522 if desired thereby decreasing the overall energy requirements of the paint system. Stated another way, in operation, a paint system of the present invention contains at least one paint pot, at least one pump circulating at least one paint stream drawn from the at least one paint pot, and at least one eductor in fluid communication with both the at least one pump and the at least one paint pot. It will be further appreciated that FIGS. 10 and 11 illustrate a second paint stream line 47 being circulated to a second paint pot 160B, whereby a second pump 150B circulates the second paint stream 47 thereby establishing fluid communication between a second eductor 522B and the second paint pot 160B.

In further accordance with the present invention and with the description given above, a method of mixing paint within a paint vessel is characterized by first providing a paint source within a mixing vessel, then circulating or pumping a paint stream, then returning the paint stream through an eductor in fluid communication with the mixing vessel to draw paint from the mixing vessel, then returning the paint stream and the drawn paint to the mixing vessel. It should be appreciated that a paint system and a method of mixing a plurality of paint streams within the paint system is defined as containing a plurality of paint streams may be independently pumped from a corresponding plurality of paint mixing vessels, whereby each of said plurality of paint streams is routed through one of a corresponding plurality of eductors by pumping said paint stream through one of a corresponding plurality of pumps. Accordingly, a plurality of paint lines is provided wherein each paint line incorporates at least one eductor fluidly communicating with a paint pump, a paint mixing vessel, and a paint return line, thereby providing an improved method of mixing paint.

It should be understood that the preceding is merely a detailed description of various embodiments of this invention and that numerous changes to the disclosed embodiments can be made in accordance with the disclosure herein without departing from the spirit or scope of the invention. The preceding description, therefore, exemplifies but should not be construed to limit the scope of the invention.

What is claimed is:

1. A paint system comprising:
at least one paint mixing vessel containing paint;
at least one pump for circulating a paint stream drawn from the mixing vessel;
at least one return line for passage of the paint stream; and
at least one eductor in fluid communication with said at least one paint mixing vessel, and said at least one pump, and said at least one return line, a portion of said eductor submerged within said at least one paint mixing vessel,
whereby in operation, paint is pumped through said at least one return line through said at least one eductor, thereby drawing a first drawn paint from said at least one paint mixing vessel and mixing said paint stream within said at least one return line with said first drawn paint, said paint stream and said first drawn paint initially drawn from the same at least one paint mixing vessel, and said paint system void of any mechanical agitator during steady state operations.

2. The paint system of claim 1 further comprising:
a second paint mixing vessel containing paint;
a second pump for circulating a second paint stream drawn from the second mixing vessel;
a second return line for passage of the second paint stream; and
a second eductor in fluid communication with said second paint mixing vessel, and said second pump, and said second return line, a portion of said second eductor submerged within said second paint mixing vessel,
whereby in operation, paint is pumped through said second return line through said second eductor, thereby drawing a second drawn paint from said second paint mixing vessel and mixing said second paint stream with said second drawn paint, said second paint stream and said second drawn paint initially drawn from the second paint mixing vessel.

3. The paint system of claim 1 further comprising:
a plurality of paint mixing vessels, each vessel containing paint;
a plurality of pumps wherein each pump in said plurality of pumps corresponds to a respective paint mixing vessel and each paint mixing vessel corresponds to a respective paint stream, each of said pumps employed for circulation of said respective paint stream drawn from each respective mixing vessel;
a plurality of return lines wherein each return line corresponds to a respective paint mixing vessel for passage of a respective paint stream for circulation thereof; and
a plurality of eductors wherein each eductor fluidly communicates with a corresponding one of said plurality of return lines, and each eductor fluidly communicates with a corresponding paint mixing vessel, and a respective portion of each eductor is submerged within its respective corresponding paint mixing vessel,
wherein during operation of said paint system, each eductor draws paint from a respective paint mixing vessel for mixing within a respective paint stream within a respective return line, each of said respective paint streams and said drawn paint from each eductor being initially drawn from the same respective paint mixing vessel.

4. A method of mixing paint within a paint system, the method comprising the steps of:
pumping a first paint stream from a mixing vessel through the paint system;
circulating the first paint stream through the system into a first paint return line in fluid communication with the mixing vessel; and
passing the first paint stream through an eductor in fluid communication with the mixing vessel to draw paint from the mixing vessel and thereby mix the drawn paint with paint being circulated in the return line,
whereby the paint system is void of any mechanical agitation during steady state operation.

5. A paint system comprising:
at least one paint mixing vessel containing paint;
at least one pump for circulating a paint stream drawn from the mixing vessel;
at least one return line for passage of the paint stream; and
at least one eductor in fluid communication with said at least one paint mixing vessel, and said at least one pump, and said at least one return line, a portion of said eductor submerged within said at least one paint mixing vessel,
whereby in operation, paint is pumped through said at least one return line through said at least one eductor, thereby drawing paint from said at least one paint mixing vessel and mixing said paint stream within said at least one return line with said drawn paint, said paint system absent any mechanical agitation during steady state operation of the paint system.

6. A paint system comprising:
at least one paint mixing vessel containing paint and no mechanical agitators;
at least one pump for circulating a paint stream drawn from the mixing vessel;
at least one return line for passage of the paint stream; and
at least one eductor in fluid communication with said at least one paint mixing vessel, and said at least one pump, and said at least one return line, a portion of said eductor submerged within said at least one paint mixing vessel for mixing said paint during steady state operation of said paint system, said at least one eductor providing the only mixing for the paint system during steady state operations.

7. The paint system of claim 6 wherein said system comprises a plurality of paint mixing vessels containing paint and no mechanical agitators, a plurality of pumps corresponding to each of said plurality of paint mixing vessels, a plurality of return lines corresponding to each of said plurality of paint mixing vessels, and a plurality of eductors wherein the eductors at least correspond to each of said plurality of paint mixing vessels.
